(19) United States
(12) Patent Application Publication
(10) Pub. No.: US 2012/0210956 A1
(43) Pub. Date: Aug. 23, 2012

(54) ENGINE COOLING DEVICE

(75) Inventors: Nozomi Sasaki, Susono-shi (JP); Shinichiro Nogawa, Mishima-shi (JP); Daishi Takahashi, Susono-shi (JP)

(73) Assignee: TOYOTA JIDOSHA KABUSHIKI KAISHA, Toyota-shi, Aichi-ken (JP)

(21) Appl. No.: 13/505,359

(22) PCT Filed: Nov. 4, 2009
(86) PCT No.: PCT/JP2009/068819

§ 371 Date: May 1, 2012

(51) Int. Cl. F02F 1/10

(52) U.S. Cl. 123/41.72

(57) ABSTRACT

The cooling device 1 includes the engine 50 having a cylinder block 51 provided with a partial W/J 511a circulating a coolant in a periphery of a cylinder 51a. In the cooling device 1, an outer wall portion W2 of a wall portion forming the partial W/J is made of a material having a heat conductivity lower than a material of an inner wall portion of the wall portion, the inner wall portion W1 facing the outer wall portion W2 and being located in the cylinder 51a side.

### TECHNICAL FIELD

The present invention relates to an engine cooling device.

### BACKGROUND ART

Conventionally, an engine is generally cooled by coolant. Generally, a coolant passageway is provided around a cylinder of the cylinder block, so that a coolant is circulated through the coolant passageway, in order to perform such cooling. In contrast, Patent Document 1 discloses a four-cycle internal combustion engine, according to the present invention, which has a cylinder bore wall forming a combustion chamber and partially having heat insulation structure.

Patent Document 1: Japanese Unexamined Patent Application Publication No. 2000-73770

### DISCLOSURE OF THE INVENTION

### Problems to be Solved by the Invention

Incidentally, an engine, especially, a spark-ignited internal combustion engine generates much heat which is caused by an exhaust loss or a cooling loss and which is not used for the actual work, as shown in FIG. 8. It is very important to reduce the cooling loss having a big ratio in the whole energy loss for the improvement of the heat efficiency (the mileage). However, it is not always easy to reduce the cooling loss and to use heat effectively. This prevents the improvement of heat efficiency.

For example, the reason it is difficult to reduce the cooling loss is that a general engine cannot partially change the heat transfer state. That is, it is difficult to cool a part necessary to be cooled by the only the necessary degree, in consideration of the structure of the general engine. Specifically, to change the heat transfer state of the engine, the flow rate of the coolant is changed in response to the engine rotational number by a mechanical water pump driven by the output of the engine. However, even if the adjustable water pump temporarily changing the flow rate is used as the water pump entirely regulating the flow rate of the coolant, the heat transfer state cannot be partially changed in response to an engine driving state.

Also, for example, it is conceivable that the heat insulation of the engine is raised for reducing a cooling loss. In this case, the large reduction of the cooling loss can be expected as shown in FIG. 9. However, the improvement of the heat insulation also increases the inner wall temperature of the combustion chamber at the same time. Further, in this case, this increases the temperature of the air-fuel mixture, thereby causing a problem of knocking. Additionally, the similar problem is concerned about the technology disclosed in Patent Document 1.

Thus, the present invention has been made in view of the above circumstances and has an object to provide an engine cooling device suppressing heat from being radiated to the outside of an engine, suppressing knocking, and satisfying both of the acceleration of warm-up of the engine and the reduction of the cooling loss. The present invention also provides an engine cooling device satisfying both of the reduction of the cooling loss and the property of knocking by partially changing the heat transfer of the engine in a rational manner.

### Means for Solving the Problems

According to an aspect of the present invention, there is provided an engine cooling device including an engine provided with a cylinder block, a cooling medium passageway circulating a cooling medium in a periphery of a cylinder, wherein: an outer wall portion of a wall portion forming the cooling medium passageway is made of a material having a heat conductivity lower than a material of an inner wall portion of the wall portion, the inner wall portion facing the outer wall portion and being located in the cylinder side,

In the above configuration, the engine preferably includes a cylinder head; a cooling capacity adjusting portion suppresses a cooling capacity of the cylinder head without suppressing a cooling capacity of the cylinder block; and a control portion controls the cooling capacity of the cylinder head to be suppressed by controlling the cooling capacity adjusting portion.

### Effects of the Invention

According to the present invention, heat can be suppressed from being radiated to the outside of an engine, knocking is suppressed, and both of the acceleration of warm-up of the engine and the reduction of the cooling loss can be satisfied. Also, according to the present invention, both of the reduction of the cooling loss and the property of knocking can be satisfied by partially changing the heat transfer of the engine in a rationale manner.

### BRIEF DESCRIPTION OF THE DRAWINGS

FIG. 1 is a schematic view of an engine cooling device (hereinafter, simply referred to as cooling device) 1;

FIG. 2 is a schematic view of a cross section of a cylinder of an engine 50;

FIG. 3 is a schematic view of an ECU 70;

FIG. 4 is a schematic view of categories the engine driving state;

FIG. 5 is a schematic view of a flowchart of the operation of the ECU 70;

FIG. 6 is a schematic view of a heat transfer rate and a surface area ratio of a combustion chamber 55 in response to a crank angle;

FIG. 7 is a schematic view of a heat efficiency of the cooling device 1 in response to a load; additionally, for comparison, FIG. 7 also shows a cooling device 1X substantially identical to the cooling device 1, except that a flow rate control valve 14 is not provided in the cooling device 1X;

FIG. 8 is a view of a breakdown of the general heat balance of a spark-ignited internal combustion engine in each case of full load and partial load; and

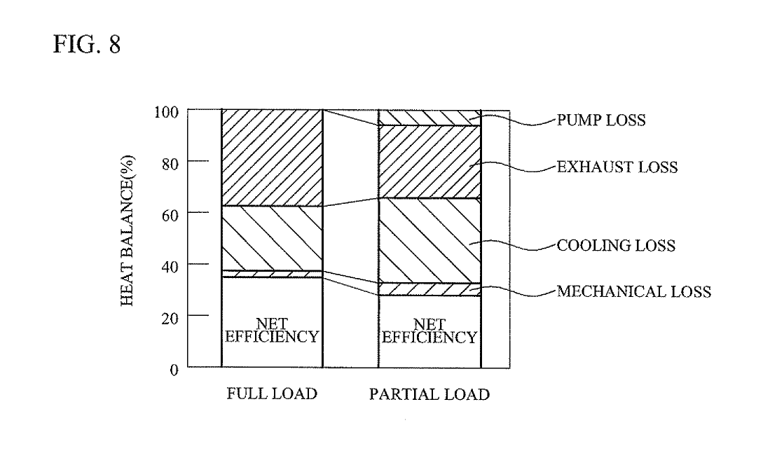

FIG. 9 is a view of an inner wall temperature and heat transmissivity of the cylinder in each case of the normal and the high insulation, additionally, FIG. 9 illustrates a case where the cylinder wall thickness is increased and its material is changed and a case where air insulation is performed with high performance, as the case of the high insulation; and FIG. 9 illustrates a general engine provided with a coolant circulation passageway of one system through which a coolant flows from a cylinder block lower portion to a head against gravitational force.

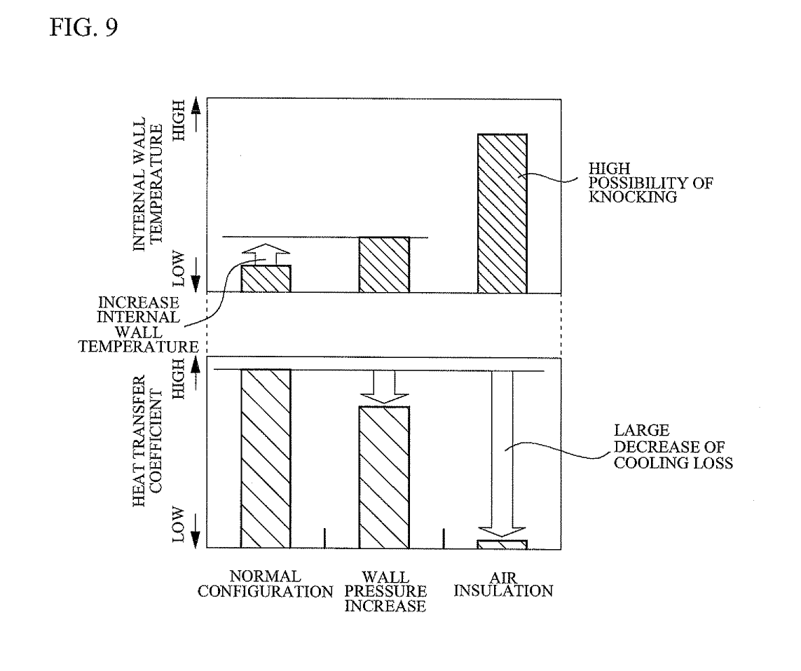

### BEST MODES FOR CARRYING OUT THE INVENTION

The embodiment according to the present invention will be described in detail with reference to drawings.

### First Embodiment 1

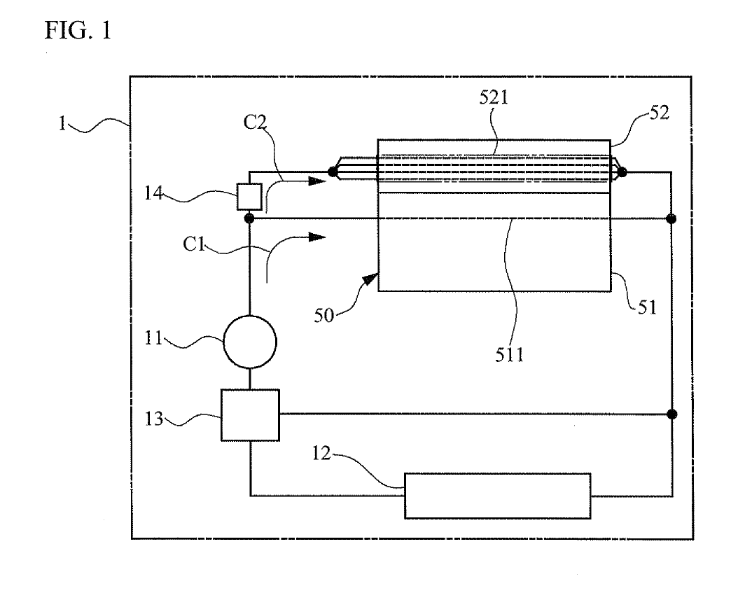

A cooling device 1 shown in FIG. 1 is mounted on a vehicle not illustrated, and is provided with a water pump (hereinafter, referred to as W/P) 11, a radiator 12, a thermostat 13, the flow rate control valve 14, and an engine 50. The W/P 11 corresponds to a cooling medium pressure feeding portion, and is an adjustable W/P feeding the coolant as a cooling medium and changing the flow rate thereof. The coolant force-fed by the W/P 11 is supplied to the engine 50.

The engine 50 includes a cylinder block 51 and a cylinder head 52. The cylinder block 51 is provided with a block side water jacket (hereinafter, referred to as block side W/J) which is a first cooling medium passageway. The block side W/J 511 forms a single cooling system in the cylinder block 51. On the other hand, the cylinder head 52 is provided with a head side water jacket (hereinafter, referred to as head side W/J) which is a second cooling medium passageway. The head side W/J 521 forms plural (herein, four) different cooling systems at the cylinder head 52. Specifically, the coolant pressure-fed by the W/P 11 is supplied to the block side W/J 511 and the head side W/J 521.

In this regard, plural coolant circulation passageways are provided in the cooling device 1. For example, for a coolant circulation passageway, there is a block side circulation passageway C1 into which the block side W/J 511 is incorporated. After the coolant is discharged from the W/P 11, the coolant flowing into this block side circulation passageway C1 flows through the block side W/J 511, and returns to the W/P 11 either via the thermostat 13 or via the thermostat 13 and the radiator 12.

The radiator 12 is a heat exchanger, and exchanges heat between the flowing coolant and air to cool the coolant. The thermostat 13 switches circulation passageways communicating with the entrance side of the W/P 11. Specifically, the thermostat 13 permits the circulation passageway bypassing the radiator 12 to be the communication state, when the coolant temperature is less than a predetermined value. The thermostat 13 permits the circulation passageway circulating with the radiator 12 to be a communication state, when the coolant temperature is equal to or more than the predetermined value.

Also, for example, for a coolant circulation passageway, there is a head side circulation passageway C2 which is the circulation passageway into which the head side W/J 521 is incorporated. After the coolant is discharged from the W/P 11, the coolant flowing into this head side circulation passageway C2 flows into the head side W/J 521, and then returns to the W/P 11 either via the thermostat 13 or via the thermostat 13 and the radiator 12. In the head side circulation passageway C2, the flow rate control valve 14 is provided in the downstream of a divergent portion of the circulation passageways C1 and C2 and in the upstream of the cylinder head 52.

The flow rate control valve 14 corresponds to a cooling capacity adjusting portion which can adjust the cooling capacity of the cylinder head 52. In this regard, the flow rate control valve 14 corresponds to a cooling capacity adjusting portion which can entirely adjust the cooling capacity of the cylinder head 52 by entirely adjusting the flow rate of the coolant circulating in the head side W/J 521. Further, the flow rate control valve 14 provided in such a way corresponds to a cooling capacity adjusting portion which can suppress the cooling capacity of the cylinder head 52 without suppressing the cooling capacity of the cylinder block 51. Specifically, for example, the flow rate control valve 14 serves as a cooling capacity adjusting portion which can suppress the cooling capacity of the cylinder head 52 without suppressing the cooling capacity of the cylinder block 51 in high rotation and high load state where the coolant is flowed into the cylinder block 51 and the cylinder head 52 in high load and high rotation state. Further, the flow rate control valve 14 provided in the above manner corresponds to a cooling capacity adjusting portion which can adjust the flow rate of the coolant circulating through in the block side W/J 511 to improve the cooling capacity of the cylinder block 51, when adjusting the flow rate of the coolant circulating through the head side W/J 521 is adjusted to suppress the cooling capacity of the cylinder head 52.

In the cooling device 1, after the coolant circulating through the block side circulation passageway C1 is pressure-fed by the W/P 11, the coolant does not flow to the head side W/J 521 before the coolant fully circulates. Further, in the cooling device 1, after the coolant circulating through the head side circulation passageway C2 is pressure-fed by the W/P 11, the coolant does not flow into the block side W/J 511 before the coolant fully circulates. That is, in the cooling device 1, the block side W/J 511 and the head side W/J 521 are respectively incorporated into a different cooling medium circulation passageway.

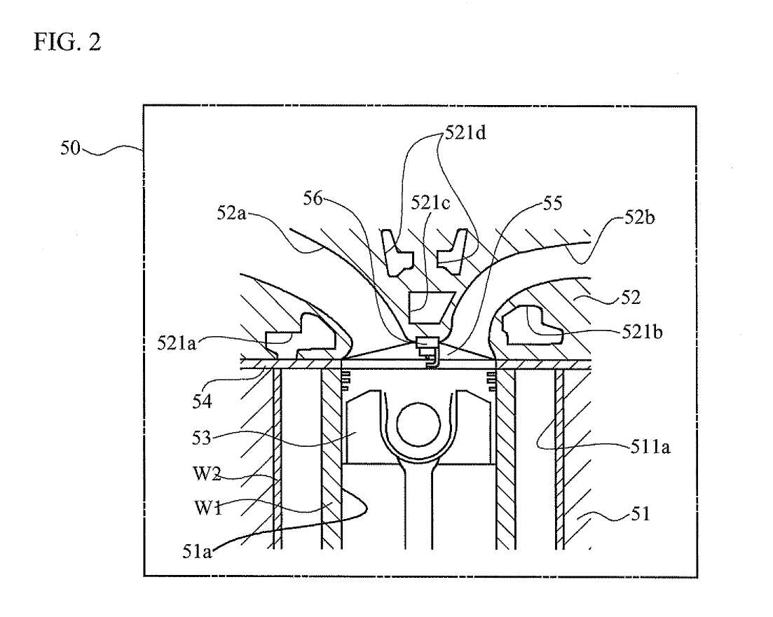

Next, the engine 50 will be explained in more detail. As shown in FIG. 2, a cylinder 51a is provided in the cylinder block 51, and a piston 53 is formed by the cylinder 51a. The cylinder head 52 is fixed to the cylinder block 51 through a gasket 54. The gasket 54 has a heat conductivity, and this high heat conductivity permits heat transfer between the cylinder block 51 and the cylinder head 52. A combustion chamber 55 is defined by the cylinder head 52, the cylinder 51a, and the piston 53. The cylinder head 52 is provided with an intake port 52a leading intake air to the combustion chamber 55 and an exhaust port 52b exhausting combustion gases from the combustion chamber 55. A spark plug 56 is provided in the cylinder head 52 so as to substantially face the upper and center of the combustion chamber 55.

The block side W/J 511 includes a partial W/J 511a corresponding to a first partial cooling medium passageway. The partial W/J 511 a is a cooling medium passageway which is provided in the periphery of the cylinder 51a. In light of desirable cooling of the intake air, the upstream side of the partial W/J 511a can be provided to correspond to a portion, among the wall of the cylinder 51a, which is hit by the intake air that has flown into the cylinder. In the regard, the engine 50 generates a forward tumble flow in a cylinder, the portion where is hit by the intake air that has flow into the cylinder corresponds to the upper portion of the wall surface of the cylinder 51a and to the exhausted side.

An inner wall portion W1 and an outer wall portion W2 forms a partial W/J 511a. The inner wall portion W1 is located at the cylinder 51a side, and the outer wall portion W2 faces the inner wall portion W1. The outer wall portion W2 is made of a material having a heat conductivity lower a material of the inner wall portion W1. Specifically, the inner wall portion W1 is made of a high heat conductive material, and the outer wall portion W2 is made of a low heat conductive material. In this regard, specifically, for example, aluminum alloy or copper is applicable to the high heat conductive material. In contrast, specifically, for example, SUS, Ti, or resin is applicable to the low heat conductive material. For example, the inner wall portion W1 can be formed by a part of the cylinder block 51 or a cylinder liner. In contrast, for example, the outer wall portion W2 can be formed by press fitting or applying.

The head side W/J 521 specifically includes multiple parts of a partial W/J 521a, a partial W/J 521b, a partial W/J 521c, and a partial W/J 521d corresponding to the second partial cooling medium passageway. The partial W/J 521a corresponds to the cooling medium passageway provided in the periphery of the intake port 52a. The partial W/J 521b corresponds to the cooling medium passageway provided in the periphery of the exhaust port 52b. The partial W/J 521 c corresponds to the cooling medium passageway provided in the periphery of the spark plug 56. The partial W/J 521d corresponds to the cooling medium passageway provided for cooling a portion between the intake and exhaust ports 52a and 52b and another portion. The flow rate control valve 14 is provided to correspond to the partial W/J 521a to W/J 521d.

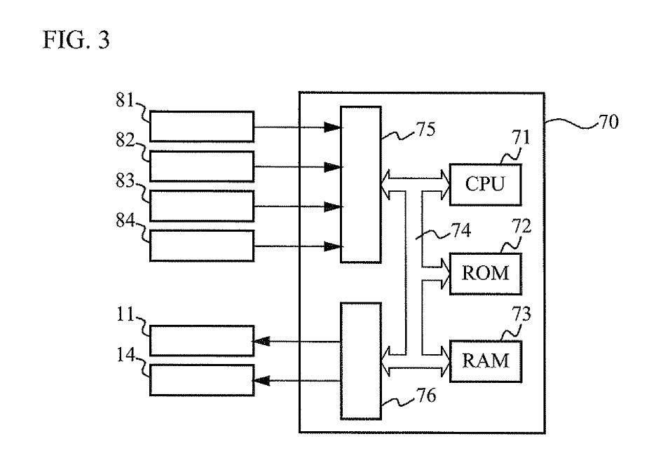

Additionally, the cooling device 1 includes an Electronic Control Unit (ECU) 70 shown in FIG. 3. The ECU 70 includes a microcomputer of a CPU 71, a ROM 72, a RAM 73, and the like, and input-output circuits 75 and 76. These configurations are connected to each other via a bus 74. The ECU 70 is electrically connected with various sensors or switches such as a crank corner sensor 81 for detecting the rotational number of the engine 50, an air flow meter 82 for measuring the amount of air intake, an accelerator opening sensor 83 for detecting the degree of an accelerator opening, and a water temperature sensor 84 for detecting the temperature of the coolant. The ECU 70 detects the load of the engine 50 based on the outputs of the air flow meter 82 and the accelerator opening sensor 83. Also, the ECU 70 is electrically connected with various control objects such as the W/P 11, and the flow rate control valve 14.

The ROM 72 stores map data or programs about various kinds of processings performed by the CPU 71. The CPU 71 processes based on a program stored in the ROM 72 and uses a temporary memory area of the RAM 73 if necessary, whereby the ECU 70 functions as various portions such as a control portion, a determination portion, a detecting portion, and a calculating portion.

For example, the ECU 70 functions as a control portion for controlling the cooling capacity of the cylinder head 52. When an engine driving state is in a high load state, the control portion suppresses the cooling capacity of the cylinder head 52. More specifically, when an engine driving state is in a low rotation and high load one, the cooling capacity exerted by the head side W/J 521 is suppressed by controlling the flow rate control valve 14.

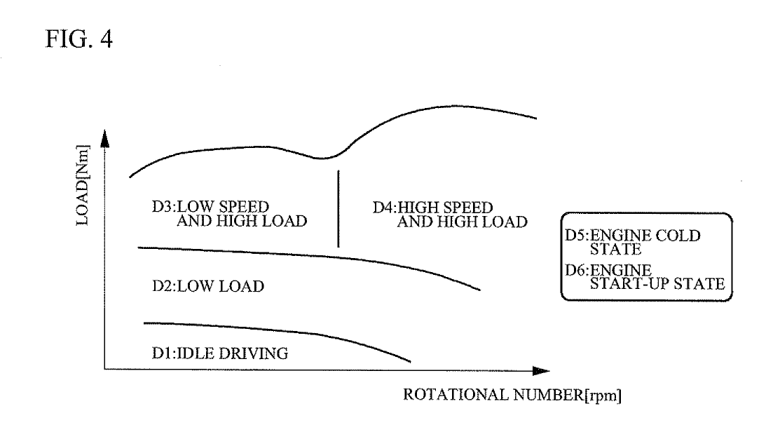

Further, the control portion achieves a control for ensuring the drive of the engine 50 in the high-load driving state in addition to any other driving states. In this regard, the engine driving state is classified into six divisions D1 to D6 as illustrated in FIG. 4, in response to the number of the rotation of the engine 50, the load thereof, the cold driving state, and the engine stating state. In control of the control portion, the control portion sets requirements to be satisfied in each of the divisions D1 to D6, and control indications for satisfying the set requirements.

When the engine driving state is an idle state corresponding to the division D1, two requirements are set for improving a combustion speed depending on the increase in the intake air temperature, and for increasing an exhaust gas temperature to active catalyst. In response to this, two control indications are set for increasing the temperatures of the intake port 52a and the upper portion of the cylinder 51a, and for increasing the temperature of the exhaust port 52b. In this regard, to increase the temperature of the intake port 52a, for example, the flow rate control valve 14 is closed or is opened with a small opening. Also, to increase the temperature of the upper portion of the cylinder 51a, for example, the W/P 11 is stopped or is driven with a low discharge volume. Also, to increase the temperature of the exhaust port 52b, for example, the flow rate control valve 14 is closed or is opened with a small opening.

Further, when the engine driving state has a low load corresponding to the division D2, two requirements are set for improving the heat efficiency (reducing the cooling loss), and for improving the combustion speed by increasing the intake air temperature. In response to this, two control indications are set for the insulation of the cylinder head 52, and for the increase in the temperatures of the intake port 52a and the upper portion of the cylinder 51a. In this regard, to insulate the cylinder head 52, for example, the flow rate control valve 14 is closed or is opened with a small opening.

Further, to increase the temperature of the intake port 52a, for example, the flow rate control valve 14 is closed or is opened with a small opening. Furthermore, to increase the temperature of the upper portion of the cylinder 51a, for example, the W/P 11 is stopped or is driven with a low discharge volume.

Further, when the engine driving state is in a low rotation and high load state corresponding to the division D3, the requirements are set for reducing the knocking and for improving the heat efficiency (reducing the cooling loss). In response to this, there are set two control indications for cooling the intake port 52a and the upper portion of the cylinder 51a and for insulating the cylinder head 52. In this regard, in order to cool the intake port 52a, for example, the flow rate control valve 14 is fully opened or is opened with a great opening. Furthermore, in order to cool the upper portion of the cylinder 51a, for example, the W/P 11 is driven with the maximum discharge volume or the high discharge volume applied in the engine driving state. Also, in order to insulate the cylinder head 52, for example, the flow rate control valve 14 is closed or is opened with a small opening.

When the engine driving state is in a high rotation and high load state corresponding to the division D4, two requirements are set for ensuring reliability and reducing the knocking. In response to this, two control indications are set for cooling the periphery of the spark plug 56, the portion between the intake and exhaust ports 52a and 52b, and for cooling the intake port 52a. In this regard, to cool the periphery of the spark plug 56, the portion between the intake and exhaust ports 52a and 52b, and the exhaust port 52b, for example, the flow rate control valve 14 is fully opened. Further, in order to cool the intake port 52a, for example, the flow rate control valve 14 is fully opened. On the other hand, for the reduction of the knocking, for example, the upper portion of the cylinder 51a is cooled in addition to the cooling of the intake port 52a. To cool the upper portion of the cylinder 51a, for example, the W/P 11 is driven with the greatest discharge volume applied in the engine driving state.

When the engine is cold to correspond to the division D5, two requirements are set for accelerating warm-up of the engine and improving the combustion speed depending on the increase in the intake air temperature. In response to this, two control indications are set for accelerating the heat transfer of the cylinder head 52 and for increasing the temperatures of the intake port 52a and the upper portion of the cylinder 51a. In this regard, in order to accelerate the heat transfer of the cylinder head 52, for example, the flow rate control valve 14 is opened in consideration of the large contribution to the heat which the coolant receives in the cylinder head 52. Also, in order to increase the temperature of the intake port 52a, for example, the flow rate control valve 14 is closed, or is opened with a small opening. Also, in order to increase the temperature of the upper portion of the cylinder 51a, for example, the W/P 11 is stopped or is driven with a low discharge volume,

When the engine starts to correspond to the division D6, two requirements are set for improving the ignition property and for accelerating the fuel vaporization. In response to this, two control indications are set for increasing the temperature of the intake port 52a, and for increasing the temperatures of the periphery of the spark plug 56 and the cylinder 51a. In this regard, in order to increase the temperature of the intake port 52a, for example, the flow rate control valve 14 is closed, or is opened with a small opening. Also, in order to increase the temperature of the periphery of the spark plug 56, for example, the flow rate control valve 14 is closed or is opened with a small opening. Further, in order to increase the temperature of the cylinder 51a, for example, the W/P 11 is stopped or is driven with a low discharge volume.

Meanwhile, in the cooling device 1, the control portion controls the W/P 11 to basically increase the discharge volume as the number of the rotation of the engine 50 is increased, in light of the consistency or the simplification of the entire control. On the other hand, the flow rate control valve 14 is controlled in the following manner.

That is, the control portion controls the flow rate control valve 14 to close, when the engine driving state is an idle state corresponding to the division D1, is in a low load corresponding to the division D2, is cool corresponding to the division D5, or is in a starting state corresponding to the division D6. When the engine driving state is in low rotation and high load state, the control portion controls the flow rate control valve 14 to close, or to open in such a manner that the coolant is suppressed from flowing through the cylinder head 52 and from boiling in the cylinder head 52 (hereinafter, referred to as boiling suppression manner). Further, when the engine driving state is in high rotation and high load state corresponding to the division D4, the control portion controls the flow rate control valve 14 to fully open.

In this regard, in order to control the flow rate control valve 14 in the boiling suppression manner at the time the engine driving state is in low rotation and high load state corresponding to the division D3, the control portion can control the flow rate control valve 14 to open with a necessity minimum opening so as to suppress the coolant from boiling. Further, the control portion can detect or estimate the temperature flowing through the cylinder head 52, and can control the flow rate control valve 14 to intermittently open in response to the temperature of the coolant. Furthermore, the control portion can control the flow rate control valve 14 to open under a condition of a given rotation number or more. In the suppression of the coolant capacity of the cylinder head 52, the coolant can be suppressed from boiling and the flow rate control valve 14 can be suppressed from opening more than necessary.

In the cooling device 1 in the division D3, the flow rate control valve 14 decreases the flow rate of the coolant flowing through the cylinder head 52 to locally decrease the flow rate of the coolant flowing through the engine 50, under the control of the control portion. The cooling device 1 suppresses the flow rate of the coolant flowing through the cylinder head 52 in a case where the flow rate control valve 14 is not fully opened, thereby suppressing the cooling capacity of the cylinder head 52. Specifically, the flow rate control valve 14 is closed or is opened in the boiling suppression manner in the cooling device 1, whereby the cooling capacity of the cylinder head 52 is suppressed.

Additionally, the control portion of the cooling device 1 controls the entire device in light of the consistency or the simplification of the entire control. However, the control manners are not limited to the above control manners. The control portion may arbitrarily control the W/P 11 or the flow rate control valve 14 in response to the above control indications, and may control differently from the above ways in light of the consistency or the simplification of the entire control. This can ensure the desirable driving of the engine 50.

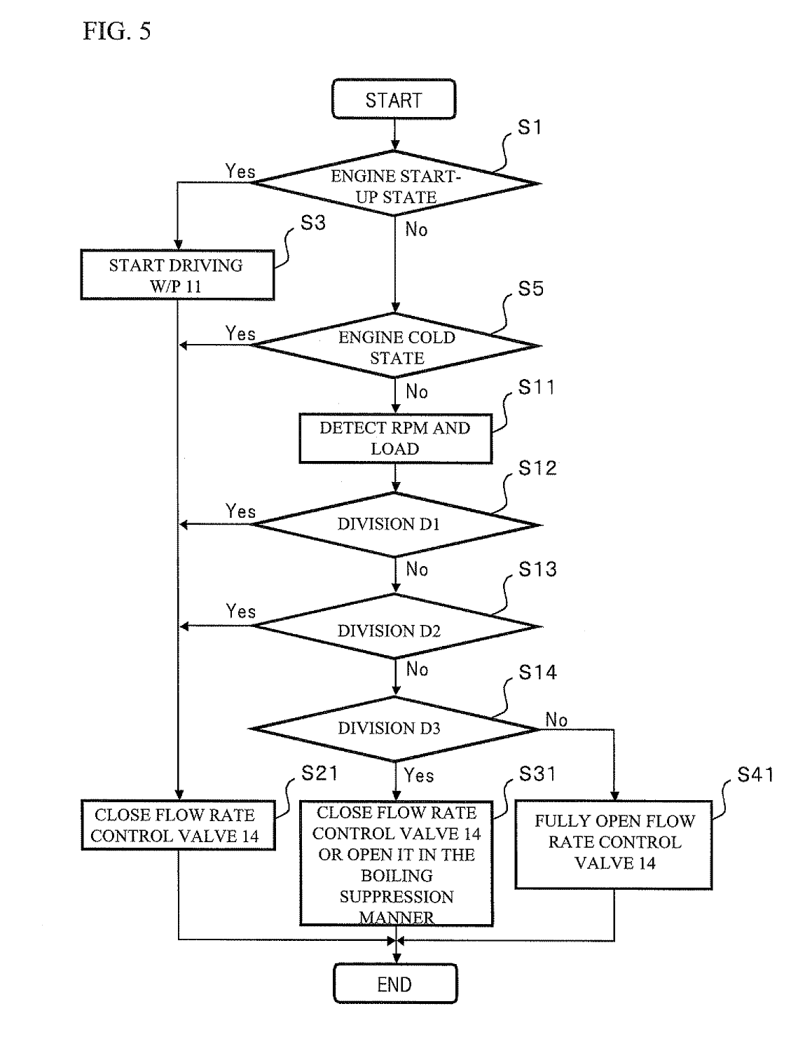

The processing performed in the ECU 70 will be described with reference to a flowchart shown in FIG. 5. The ECU 70 determines whether or not the engine 50 has just started up (step S1). If a positive determination is made, the ECU 70 starts to drive the W/P 11 (step S3). The ECU 70 then controls the flow rate control valve 14 to open (step S21). On the other hand, if a negative determination is made in step S1, the ECU 70 determines whether or not the engine 50 is cold (step S5). To determine whether or not the engine 50 is cold, for example, determines whether the coolant temperature is equal to or less than a predetermined value (for example, 75 degrees Celsius). If a positive determination is made in step S5, the processing proceeds to step S21. On the other hand, if a negative determination is made in step S5, the ECU 70 detects the rotational number or the load of the engine 50 (step S11).

The ECU 70 determines the division corresponding to the detected rotation number and load (from step S12 to S14). Specifically, when the division corresponds to the division D1, the processing continues to step S21 from the positive determination in S12. When the division corresponds to the division D2, the processing continues to step S21 from the positive determination in S13. In contrast, when the division corresponds to the division D3, the processing continues to step S31 from the positive determination in S14. In this case, the ECU 70 controls the flow rate control valve 14 to close or open in the boiling suppression manner (step S31). Further, when the division corresponds to the division D4, the processing continues to step S41 from the negative determination in S14. In this case, the ECU 70 controls the flow rate control valve 14 to fully open (step S41).

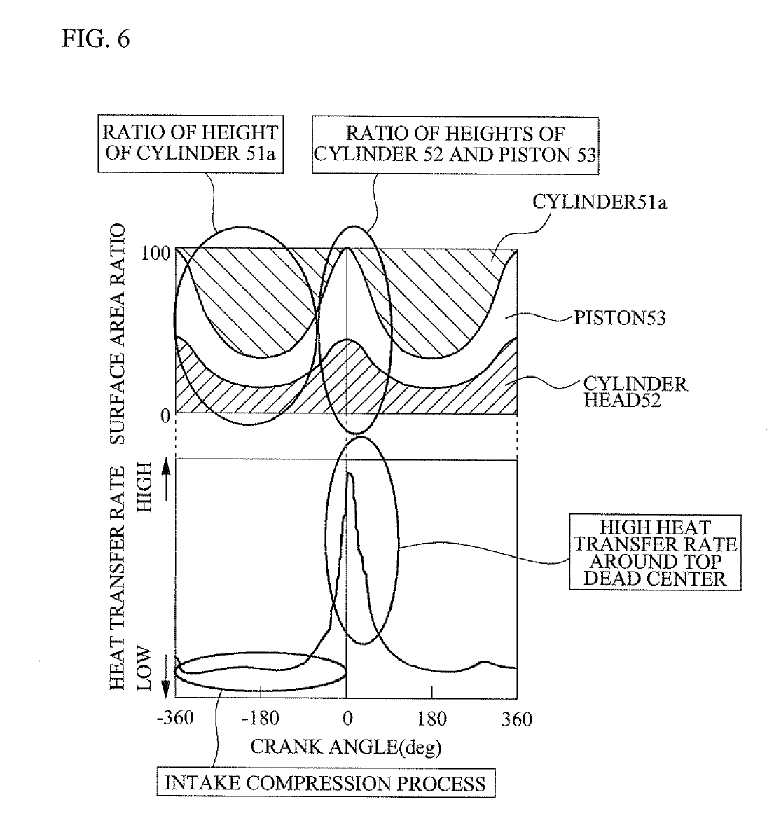

Next, the effect of the cooling device 1 will be described. Herein, FIG. 6 shows heat transfer rates and surface area ratios of the combustion chamber 55 depending on the crank angle of the engine 50. As illustrated in FIG. 6, the heat transfer rate rises around the top dead center in the compression stroke. The surface area ratio between the cylinder head 52 and the piston 53 rises around the top dead center in the compression stroke. It is thus understood that the temperature of the cylinder head 52 greatly influences the cooling loss. On the other hand, knocking depends on the compression end temperature. It is recognized that the surface area ratio of the cylinder 51a is great in the intake compression stroke temperature. It is thus understood that the temperature of the cylinder 51a greatly influences knocking.

In view of this knowledge, in the cooling device 1, the flow rate control valve 14 is closed or is opened in the boiling suppression manner, when the engine driving state is in low rotation and high load state. Therefore, the flow rate of the coolant flowing through the head side W/J 521 is limited, thereby suppressing the cooling capacity of the cylinder head 52 and reducing the cooling loss. On the other hand, the generation of knocking is worried about in this case. Correspondingly, the cooling device 1 controls the flow rate control valve 14 capable of suppressing the cooling capacity of the cylinder head 52 without suppressing the cooling capacity of the cylinder block 51, thereby limiting the flow rate of the coolant flowing through the head side W/J 521. For this reason, the cooling device 1 can maintain cooling of the cylinder 51a, thereby suppressing the knocking.

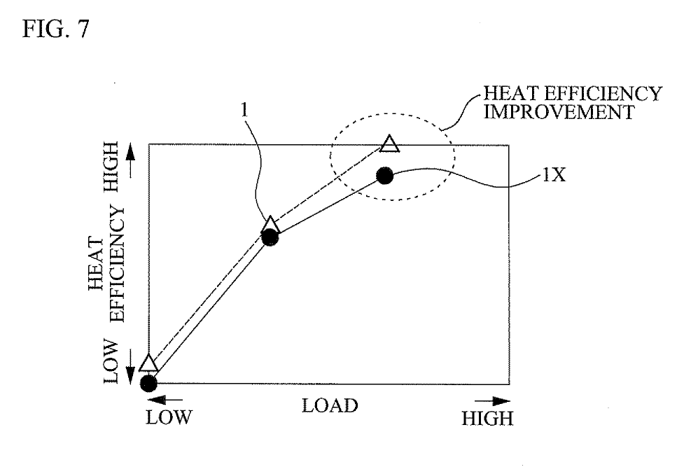

That is, in the cooling device 1, the heat transfer state is partially changed in a rational manner based on the above knowledge, thereby insulating (the reduction of the cooling loss) the cylinder head 52. Simultaneously, the cylinder block 51 is cooled, thereby suppressing the generation of knocking. Such a way ensures both of the reduction of the cooling loss and the knocking characteristics, thereby improving the heat efficiency as illustrated in FIG. 7.

Further, in the cooling device 1, when the flow rate control valve 14 adjusts the flow rate of the coolant flowing through the head side W/J 521 to suppress the cooling capacity of the cylinder head 52, the flow rate of the coolant flowing through the block side W/J 511 is adjustable to increase the cooling capacity of the cylinder block 51. Additionally, the intake air can be cooled in the cooling device 1, whereby knocking can be preferably suppressed.

Further, in the cooling device 1, the outer wall portion W2 is made of the low heat conductive material, thereby suppressing heat from being radiated from the coolant flowing through the partial W/J 511a to the outside of the engine 50 in the engine cold state. This further accelerates the warm-up of the engine in a suitable manner. Furthermore, in the cooling device 1, the inner wall portion W1 is made of the high heat conductive material. Therefore when the engine driving state is in a high load state, the cylinder 51a can be cooled by the coolant flowing through the partial W/J 511 a. For this reason, the cooling device 1 can preferably suppress knocking, and satisfy the acceleration of the warm-up of the engine and the reduction of the cooling loss. Moreover, this can suppress the deformation of the bore. In addition, the cooling device 1 has the gasket 54 with a high heat conductivity. Therefore, when the engine driving state is in a low load one, the heat transfer from the cylinder head 52 to the cylinder block 51 can increase the temperature of the upper portion of the cylinder 51a. Hence, the cooling device 1 can improve the combustion speed in a low load state.

The cooling device 1 can primarily improve the heat efficiency in low rotation and high load state, and also can ensure the driving of the engine 50 in another driving state. In this regard, the cooling device 1 can ensure the reliability and reduce knocking, in addition, the heat load applied to the catalyst caused by the reduction in the exhaust gas temperature. For this reason, the cooling device 1 can improve the heat efficiency in the entire driving state of the engine 50 in addition to the specific driving state.

While the exemplary embodiments of the present invention have been illustrated in detail, the present invention is not limited to the above-mentioned embodiments, and other embodiments, variations and modifications may be made without departing from the scope of the present invention. The above embodiment has explained an example of the W/P 11 corresponding to a cooling medium pressure feeding portion in light of the preferable driving of the engine 50. However, the present invention is not limited to this. For example, a cooling medium pressure feeding portion may be a mechanical W/P to be driven by the output of the engine.

The above embodiment has also explained an example of the control of the control portion, in the establishment of driving of the engine 50. However, the present invention is not limited to this. The control portion may arbitrarily perform another control to ensure the driving of the engine 50. In this regard, for example, the first cooling medium passageway provided in the cylinder block includes first plural part cooling medium passageways, and the second cooling medium passageway provided in the cylinder head includes second plural part cooling medium passageways. In such a case, there may be provided plural part cooling capacity adjusting portion which can partially adjust the cooling capacity of the cylinder block or the cylinder head respectively corresponding to these first and second part cooling medium passageways. In response to the control indications mentioned above, the cooling medium pressure feeding portion, the cooling capacity adjusting portion, or the part cooling capacity adjusting portion may be controlled arbitrarily. This can ensure the preferable driving state of the engine.

In the embodiment mentioned above, when the engine driving state is in low rotation and high load state corresponding to the division D3, the control portion controls the flow rate control valve 14 to close or open in the boiling suppression manner, thereby suppressing the cooling capacity exerted as each of cooling capacities of the cylinder heads 52 by each of the head side W/J 521. However, the present invention is not limited to this. For example, the cooling device may include: a retaining portion for retaining the cooling medium extracted from the second cooling medium passageway; and a cooling medium pressure feeding portion for transmitting the cooling medium between the retaining portion and the second cooling medium passageway. The control portion may control the cooling medium pressure feeding portion to at least temporally extract the cooling medium from the cylinder head, in a case where the engine driving state is in low rotation and high load state. For example, the retaining portion and the cooling medium pressure feeding portion respectively correspond to a heat storage tank and an electromotive pump disclosed in Japanese Unexamined Patent Application Publication No. 2009-79505. This can suitably reduce the cooling loss.

Also, the retaining portion, the cooling medium pressure feeding portion, and the control portion may be applied, when the engine driving state is an idle state, a low load, or a cold state. In this case, there may be provided first and second retaining portion, as the retaining portion, in which the cooling medium extracted from the first and second cooling medium passageways. There may be provided a first cooling medium pressure feeding portion, as the cooling medium pressure feeding portion, which transfers the cooling medium between the first retaining portion and the first cooling medium passageway. There may be provided a second cooling medium pressure feeding portion, as the cooling medium pressure feeding portion, which transfers the cooling medium between the second retaining portion and the second cooling medium passageway. In this case, when the common cooling media is made to flow through the first and second cooling medium passageways, the first and the second retaining portions may be combined to a single retainer, and the first and second cooling medium pressure feeding portions may be combined to a single cooling medium pressure feeding portion. This can further improve the combustion speed, reduce the cooling loss, and accelerate the engine warming up, thereby ensuring the preferable driving of the engine.

In the above embodiment, the control portion controls the flow rate control valve 14 to close, when the engine driving state is in the idle state, or the starting state. However, the present invention is not limited to this. For example, the cooling device may further include a heat storage cooling medium feed portion which can supply the first and second cooling medium passageways with the heat storage cooling medium. The control portion may control the heat storage cooling medium feed portion to supply the first and the second cooling medium passageways with the heat storage cooling medium, when the engine driving state is the idle state, or when the temperature of the heat storage cooling medium is higher than that of the cooling medium in the time of the cold state or the start up state. For example, the heat storage cooling medium feed portion corresponds to a heat exchanger disclosed in the Japanese Unexamined Patent Application Publication No. 2009-208569. In this case, the control portion may control the part cooling capacity adjusting portion is provided for corresponding to the spark plug or the exhaust port, among the part cooling capacity adjusting portion which cool partially the cooling capacity of the cylinder head, so as to control the increase in the flow rate of the heat storage cooling medium. This can accelerate the engine warming up, reduce the unburned HC, and improve the ignition property. Consequently, the engine driving can be preferably ensured.

Further, it is rational that the control portion is achieved by the ECU 70 mainly controlling the engine 50. For example, the control portion may be realized by a hardware such as another electronic controller, an exclusive electronic circuit, or any combinations thereof. Furthermore, for example, the control portion may be achieved, as a distributed control portion, by hardware such as plural electronic controllers and plural electronic circuits or a combination of hardware such as an electronic controller and an electronic circuit.

### DESCRIPTION OF LETTERS OR NUMERALS

1 Cooling device
11 W/P
12 Radiator
13 Thermostat
14 Flow rate control valve
50 Engine
51 Cylinder block
52 Cylinder head
70 ECU

1. An engine cooling device comprising an engine provided with a cylinder block, a cooling medium passageway circulating a cooling medium in a periphery of a cylinder, wherein:
an outer wall portion of a wall portion forming the cooling medium passageway is made of a material having a heat conductivity lower than a material of an inner wall portion of the wall portion, the inner wall portion facing the outer wall portion and being located in the cylinder side.

2. The engine cooling device of claim 1, wherein:
the engine includes a cylinder head;
a cooling capacity adjusting portion suppresses a cooling capacity of the cylinder head without suppressing a cooling capacity of the cylinder block; and
a control portion controls the cooling capacity of the cylinder head to be suppressed by controlling the cooling capacity adjusting portion.
